(19) United States
(12) Patent Application Publication
(10) Pub. No.: US 2026/0159154 A1
(43) Pub. Date: Jun. 11, 2026

(54) VEHICLE STEERING MOTOR ASSEMBLY

(71) Applicant: HYUNDAI MOBIS CO., LTD., Seoul (KR)

(72) Inventors: Il Ryong KIM, Yongin-si (KR); Suk Won LEE, Yongin-si (KR); Geon Woo DO, Yongin-si (KR); Young Sung KIM, Yongin-si (KR); Tae Jun WEON, Yongin-si (KR)

(73) Assignee: HYUNDAI MOBIS CO., LTD., Seoul (KR)

(21) Appl. No.: 19/311,976

(22) Filed: Aug. 27, 2025

(30) Foreign Application Priority Data
Dec. 6, 2024 (KR) 10-2024-0180453

(51) Int. Cl. B62D 5/04; H02K 5/22; H02K 7/116; H02K 11/33

(52) U.S. Cl. CPC B62D 5/0406; H02K 5/225; H02K 7/116; H02K 11/33

(57) ABSTRACT

Disclosed is a vehicle steering motor assembly including: a motor housing, in which a motor is housed; a gearbox, in which a plurality of gears rotatably connected to a motor shaft are housed; and a fastening bracket provided between the motor housing and the gearbox, wherein an end of the fastening bracket in contact with the motor housing is welded and coupled to the motor housing, and the fastening bracket connects the motor housing and the gearbox.

### CROSS REFERENCE TO RELATED APPLICATION

The present application claims priority of Korean Patent Application No. 10-2024-0180453 filed on Dec. 6, 2024, the entire contents of which is incorporated herein for all purposes by this reference.

### BACKGROUND OF THE DISCLOSURE

### Field of the Disclosure

The present disclosure relates to a vehicle steering motor assembly.

### Description of the Related Art

Electric power steering (EPS) is a steering system that uses an electric motor to assist with driver's steering operation. Unlike a hydraulic power steering system, the EPS uses an electric motor to provide steering force to assist with driver's steering operation.

The matters described above as a background art are provided solely to facilitate a better understanding of the background of the present disclosure and should not be construed as an admission that they constitute a related art already known to those skilled in the art.

### SUMMARY OF THE DISCLOSURE

An electric motor, which assists with steering, is housed in a motor housing. In addition, a bracket is provided for fastening a gearbox, which houses a plurality of gears, to the motor housing. As manufacturing the motor housing and the bracket as an integrated unit is challenging, the motor housing and the bracket may be manufactured separately and then coupled using a TOX pressing method. However, when the motor housing and the bracket are coupled, the motor housing and the bracket may be deformed due to a load generated during the pressing process.

The present disclosure is proposed to provide a vehicle steering motor assembly, which is manufactured using various welding methods, such as spot welding, seam welding, or wave welding.

Technical objectives of the present disclosure are not limited to the technical objectives mentioned above, and other technical objectives not mentioned above will be clearly understood by those skilled in the art from the following description.

A vehicle steering motor assembly according to the present disclosure includes: a motor housing, in which a motor is housed; a gearbox, in which a plurality of gears rotatably connected to a motor shaft are housed; and a fastening bracket provided between the motor housing and the gearbox, wherein an end of the fastening bracket in contact with the motor housing is welded and coupled to the motor housing, and the fastening bracket connects the motor housing and the gearbox.

In an embodiment, the motor housing may include a motor compartment covering the motor and a controller compartment, in which a controller configured to control the motor is provided.

In an embodiment, the motor compartment may have a cylindrical shape, wherein a first coupling portion may be formed at a lower end of the motor compartment for coupling with the controller compartment; and a second coupling portion may be formed at an upper end of the motor compartment, wherein the fastening bracket is coupled to the second coupling portion having an outer diameter smaller than an adjacent portion of the motor compartment.

In an embodiment, a hollow may be formed in a central portion of the fastening bracket; the fastening bracket may be inserted into the second coupling portion of the motor compartment through the hollow; and a third coupling portion coupled to the gearbox may be formed at an edge of the fastening bracket.

In an embodiment, an inner peripheral surface of the hollow of the fastening bracket and an outer peripheral surface of the second coupling portion may be welded to couple the fastening bracket and the motor compartment.

In an embodiment, a plurality of through-holes may be formed on an outer peripheral surface of the motor compartment; a plurality of protrusions protruding toward an outer peripheral surface of the motor housing may be formed on the fastening bracket; the protrusions may be inserted into the through-holes; and outer peripheral surfaces of the protrusions and inner peripheral surfaces of the through-holes may be welded to couple the fastening bracket and the motor housing.

In an embodiment, the plurality of through-holes may be disposed at equal angular intervals around the center of the motor compartment, and the plurality of protrusions may be disposed at equal angular intervals around the center of the fastening bracket.

In an embodiment, a guide protrusion configured to partially protrude in a circumferential direction may be formed on the second coupling portion of the motor compartment; and a hollow of the fastening bracket may be formed with a guide groove recessed inward to correspond to the guide protrusion.

With the vehicle steering motor assembly of the present disclosure, since a welding method is used instead of a pressing method, the vehicle steering motor assembly is not deformed. Accordingly, process management is simplified and quality control becomes easier.

The effects which may be achieved from the present disclosure are not limited to the effects mentioned above, and other effects not mentioned above will be clearly understood by those skilled in the art from the following description.

### BRIEF DESCRIPTION OF THE DRAWINGS

FIG. 1 is an exploded view illustrating a vehicle steering motor assembly according to an embodiment of the present disclosure.

FIG. 2 is an exploded view illustrating a fastening bracket and a controller compartment and a motor compartment of a motor housing.

FIG. 3 is a view illustrating the fastening bracket.

FIG. 4 is a view illustrating coupling of the fastening bracket and the motor housing.

FIG. 5 is a view illustrating the fastening bracket being coupled to the motor housing through a protrusion of the fastening bracket.

### DETAILED DESCRIPTION OF THE DISCLOSURE

In describing embodiments disclosed herein, when a detailed description of a known related art is determined to obscure the gist of the embodiments disclosed herein, the detailed description thereof will be omitted herein. In addition, the accompanying drawings are merely for easy understanding of the embodiments disclosed herein, and the technical spirit disclosed herein is not limited by the accompanying drawings, but it should be understood to include all modifications, equivalents, and substitutes included in the spirit and technical scope of the present disclosure. The following disclosure is not intended to limit the present disclosure to the described form or a specific field. It should be considered that various alternative aspects and variations of the present disclosure are possible, whether explicitly stated or implied herein. Those skilled in the art to which the present disclosure pertains will recognize that the form and details of the present disclosure may be modified.

The present disclosure is described with reference to specific aspects. However, as understood by those skilled in the art to which the present disclosure pertains, the various aspects disclosed herein may be modified or otherwise implemented in various different ways without departing from the spirit and scope of the present disclosure. Accordingly, the following description should be considered exemplary and is intended to instruct those skilled in the art to which the present disclosure pertains on how to develop and use various embodiments. It will be understood that the forms of the disclosure illustrated and described herein are to be taken as representative embodiments. Equivalent elements, materials, processes, or steps, may be substituted with those exemplified and described in the present disclosure. As used in the present disclosure, expressions such as “including,” “comprising,” “incorporating,” “consisting of,” “have,” “is,” and the like should be construed in a non-exclusive manner, i.e., to permitting the indication of items, components, or elements not explicitly stated. In addition, references to the singular should be construed to include the plural.

In addition, the various embodiments disclosed herein should be taken in an exemplary and illustrative sense and should not be construed as limiting the scope of the present disclosure. Any references to joining (e.g., attached, affixed, coupled, connected, etc.) are used solely to facilitate better understanding of the present disclosure and are not intended to limit the location, direction, or use of the components or the method disclosed herein. Accordingly, when references to joining are present, they should be construed broadly. Furthermore, such references to joining do not imply that two or more elements are directly connected to each other. Additionally, any numerical terms, such as “first,” “second,” “third,” “primary,” “secondary,” “major,” or any other random generic or numerical terms, should be taken as identifiers solely to facilitate better understanding of the various components, forms, variations, or modifications of the present disclosure and do not imply any limitations to any component, form, variation, or modification or to any order or preference thereof. That is, these expressions may be used to describe various components, but the components are not limited by such expressions. The expressions are used solely for the purpose of distinguishing one component from another component.

As used in the following description, suffixes “module” and “part” for a component are used or interchangeably used solely for ease of preparation of the specification, and do not have different meanings and each of them does not function by itself.

When a component is referred to as being “connected” or “coupled” to another component, the component may be directly connected or coupled to another component, but it should be understood that still another component may be present between the component and another component. Conversely, when a component is referred to as being “directly connected” or “directly coupled” to another, it should be understood that still another component may not be present between the component and another component.

In addition, a unit or control unit included in names is only a term widely used in the naming of a controller that controls the specific function of a vehicle, but does not mean a generic function unit.

A controller may include a communication device for communicating with other control units or sensors to control a responsible function, a memory for storing an operating system, a logic command, and input/output information, and at least one processor for executing determination, calculation, and decision which are necessary for controlling the responsible function.

Any number of components or a variety of components in any of the configurations described herein may be included in the disclosure described herein. The components may include any combination of the features described herein, and may be arranged in any of the various configurations described herein. The concepts associated with the structure and arrangement of components, as well as their use and operation, of the present disclosure may be applied not only to certain embodiments discussed herein but also to any number and combination of embodiments. Embodiments including those having various features of various arrangements are described below with reference to the drawings.

Hereinafter, embodiments disclosed herein will be described in detail with reference to the drawings. The same reference numerals are given to the same or similar components regardless of reference numerals, and a repetitive description thereof will be omitted.

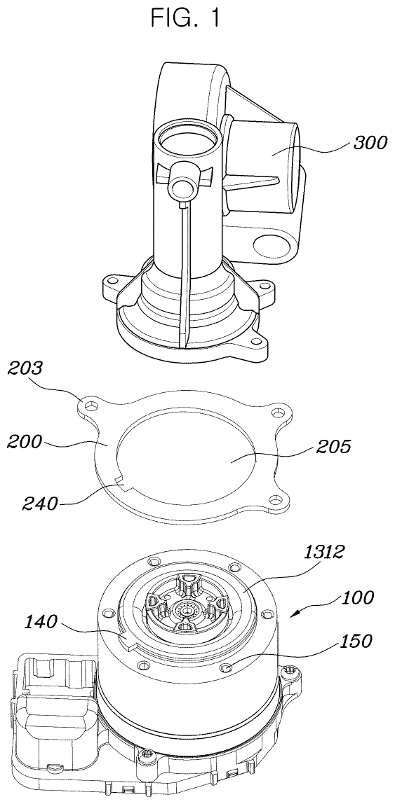

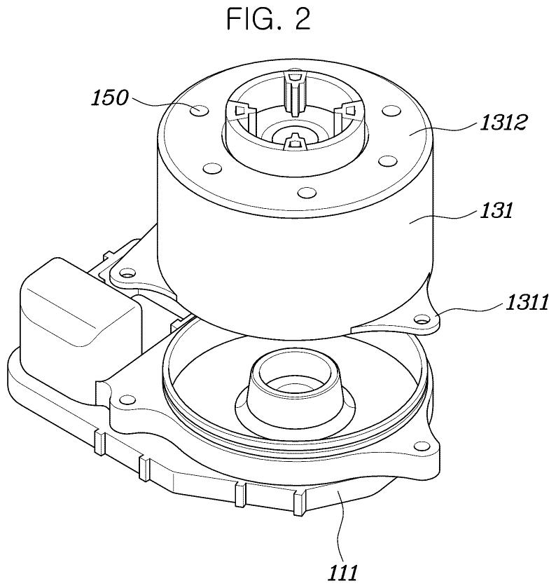

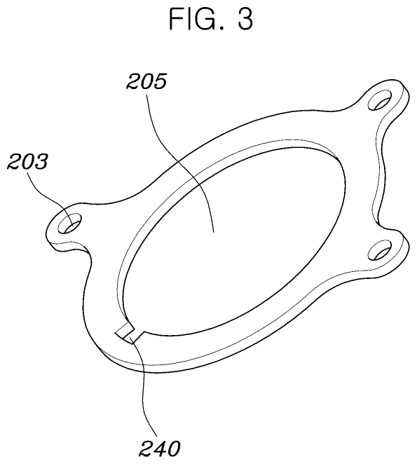

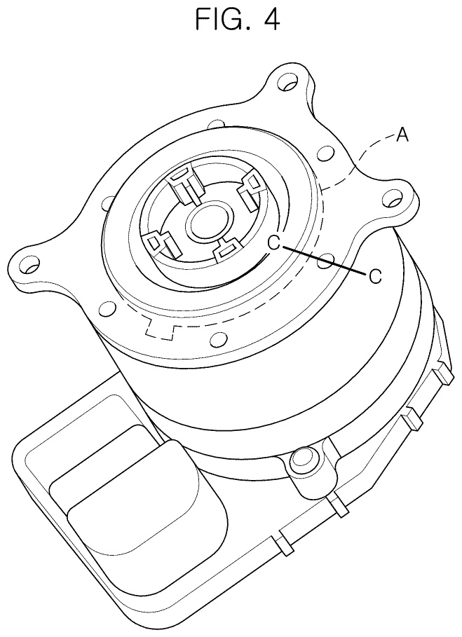

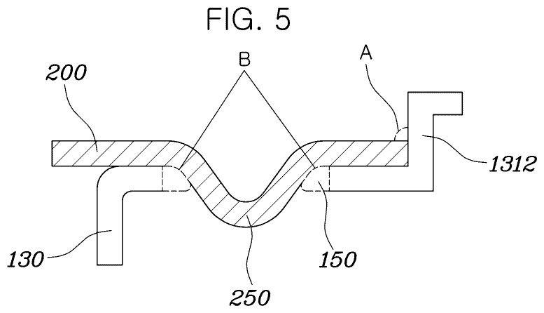

FIG. 1 is an exploded view illustrating a vehicle steering motor assembly according to an embodiment of the present disclosure. FIG. 2 is an exploded view illustrating a fastening bracket and a controller compartment and a motor compartment of a motor housing. FIG. 3 is a view illustrating the fastening bracket. FIG. 4 is a view illustrating coupling of the fastening bracket and the motor housing. FIG. 5 is a view illustrating the fastening bracket being coupled to the motor housing through a protrusion of the fastening bracket.

A vehicle steering motor assembly according to the present disclosure includes a motor housing 100, in which a motor is housed; a gearbox 300, in which a plurality of gears rotatably connected to a motor shaft are housed; and a fastening bracket 200 provided between the motor housing 100 and the gearbox 300, wherein an end of the fastening bracket 200 in contact with the motor housing 100 is welded and coupled to the motor housing 100, and the fastening bracket 200 connects the motor housing 100 and the gearbox 300.

The motor housing 100 performs functions of protecting the motor from external impact, vibration, dust, moisture, or the like, and securely supporting the motor within the vehicle steering motor assembly. The motor housing 100 may be implemented in various shapes and materials, and the structure and function of the motor housing 100 may vary depending on particular environmental conditions or requirements.

The motor housing 100 may be designed to have a cylindrical, rectangular, polygonal, or other composite shape, and may have an asymmetrical structure, if necessary, for efficient coupling between the motor and the gearbox 300.

The motor housing 100 may be made of various materials, such as metal (e.g., metal such as aluminum, iron, or magnesium, alloy containing the same, etc.), synthetic resin (e.g., polycarbonate, etc.), or composite material (e.g., carbon fiber, glass fiber-reinforced plastic, etc.). The material may be selected based on requirements such as weight or durability of the vehicle steering motor assembly. However, according to the present disclosure, the motor housing 100 is most preferably made of a metal material.

The motor housing 100 may be manufactured using various manufacturing methods, such as casting, extrusion, molding, or 3D printing, and may be manufactured as a single component or configured as an assembly of multiple components depending on the manufacturing process. In addition, the motor housing 100 may also be designed to provide a cooling structure or additional structural reinforcement therein. For example, a cooling structure (e.g., a heat dissipation fin or heat sink) to release heat generated during an operation of the motor may be contained within the motor housing 100.

The gearbox 300 serves to transmit rotational force of the motor and control vehicle steering through acceleration, deceleration, or torque conversion. The gearbox 300 may be designed in various shapes, sizes and gear arrangements and to meet functional requirements.

In particular, the gearbox 300 may be implemented in a cylindrical, rectangular, polygonal, or composite structure, and the shape of the gearbox 300 may be asymmetrical for efficient coupling with the motor and a mechanical connecting element. A plurality of gears that transmit rotational force of the motor may be contained within the gearbox 300, and the gears may be implemented in various forms such as a spur gear, a helical gear, a bevel gear, or a worm gear. The gears contained within the gearbox 300 may utilize various gear mechanisms such as a spur gear, a helical gear, a bevel gear, or a planetary gear. Each gear may have its gear ratio adjusted based on the motor's performance, vehicle characteristics, and steering requirements, and may be configured as a single-stage gear system or a multi-stage gear system.

The gearbox 300 may also be made of metal, synthetic resin, composite materials, or the like. The material may be selected based on the weight, heat resistance, or the like of the gearbox 300.

The gearbox 300 may directly connect the motor housed in the motor housing 100 and the gears inside the gearbox 300, or may include an indirect connection mechanism, such as a clutch. In addition, the gearbox 300 may be designed as a sealed configuration to protect against from mechanical damage or external environment, and in this case, dust- and water-resistant functionality is provided. Furthermore, a damper or a vibration-damping material may be applied to the gearbox 300 to absorb internal impact.

The fastening bracket 200 is a key component that connects the motor housing 100 and the gearbox 300, and has a structure in which the fastening bracket 200 is coupled to the motor housing 100 by welding. Compared to the pressing method, the welding method minimizes deformation of the motor housing 100 or the fastening bracket 200 itself during the fastening process. Accordingly, the precision and durability of components may be enhanced, and the long-term stability of the assembly may be ensured.

More specifically, the fastening bracket 200 is coupled to the motor housing 100 by welding. The welding method uses heat and pressure to firmly couple the two components, thereby preventing excessive physical deformation that may occur with the pressing method. In the pressing method, a compressive force exerted by a pressing machine is applied to a fastening point of the motor housing 100 and the fastening bracket 200, thereby potentially damaging a surface of the motor housing 100 or the fastening bracket 200 or causing structural deformation. However, the welding method minimizes such issues. Due to high pressure, the pressing method may cause slight deformation of the fastening bracket 200 or the motor housing 100, and the deformation may cause separation of the components or a reduction in the fastening strength over time. On the other hand, due to localized heat treatment, the welding method has less physical impact on an area outside a coupling portion, thereby minimizing structural deformation.

The welding method allows the components to be coupled while maintaining accurate positioning of the components, thereby reducing the possibility of a mechanical error and maintaining uniform fastening strength. These characteristics are essential for ensuring the precise operation of the gearbox 300.

The components coupled by welding form an integral structure, thereby providing greater durability against external impact and vibration. This may contribute to long-term stability of the vehicle steering motor assembly and a reduction in maintenance costs. The fastening bracket 200 may be made of a metal material (e.g., steel and aluminum alloy) and is designed to firmly connect the motor housing 100 and the gearbox 300.

A structure in which the components of the vehicle steering motor assembly are coupled will be described below in more detail.

In an embodiment, the motor housing 100 may include a motor compartment 131 that covers a motor and a controller compartment 111 in which a controller that controls the motor is provided. The motor connected to the controller is provided inside the motor housing 100, and the rotation speed, rotation direction, torque, or the like of the motor are controlled by the control of the controller. The controller may include a power module that regulates the driving and operation of the motor. The power module may be electrically connected to the motor to regulate the performance of the motor based on a control signal. The power module may precisely control the rotation speed, rotation direction, torque, or the like of the motor by controlling the current, voltage, or the like applied to the motor based on a control signal.

The motor compartment 131 may be manufactured in a roughly cylindrical shape. A first coupling portion 1311 may be formed at a lower end of the motor compartment 131 for coupling with the controller compartment 111, and a second coupling portion 1312 may be formed at an upper end of the motor compartment 131, wherein the fastening bracket 200 is coupled to the second coupling portion 1312 having an outer diameter smaller than an adjacent portion of the motor compartment.

Specifically, the first coupling portion 1311 formed at the lower end of the motor compartment 131 has a structure designed for coupling with the controller compartment 111, and provides a precise coupling method such that the controller compartment 111 may be stably mounted. The coupling portions may employ various coupling methods such as bolting, clipping, or press-fitting, and ensure mechanical strength and stability for coupling.

The second coupling portion 1312 having an outer diameter smaller than an adjacent portion may be formed at the upper end of the motor compartment 131, which is a customized structure designed for coupling with the fastening bracket 200. The second coupling portion 1312 is manufactured in a size and shape exactly corresponding to a hollow 205 of the fastening bracket 200, thereby providing high assembly precision.

The hollow 205 is formed in a central portion of the fastening bracket 200, and the hollow 205 has an inner diameter corresponding to an outer diameter of the second coupling portion 1312. During the coupling process, the second coupling portion 1312 of the motor compartment 131 is inserted through the hollow 205 of the fastening bracket 200, and an inner peripheral surface of the hollow 205 and an outer peripheral surface of the second coupling portion 1312 are fixed by welding. Referring to FIG. 4, welding is uniformly performed along line A illustrated along a periphery of the outer peripheral surface of the second coupling portion 1312, thereby ensuring long-term stability.

The fastening bracket 200 has a predetermined thickness, which is designed to ensure impact absorption and durability against an external load. An appropriate thickness allows efficient transmission of force between the motor compartment 131 and the gearbox 300 after fastening, and prevents excessive stress concentration at a coupling portion.

In this way, the motor housing 100 and the fastening bracket 200 are coupled, and a third coupling portion 203 coupled to the gearbox 300 may be formed at an edge of the fastening bracket 200.

In addition, an additional structure may be further formed for coupling the motor housing 100 and the fastening bracket 200. In an embodiment, a plurality of through-holes 150 may be formed on an outer peripheral surface of the motor compartment 131; a plurality of protrusions 250 configured to protrude toward an outer peripheral surface of the motor housing 100 may be formed on the fastening bracket 200; the protrusions 250 may be inserted into the through-holes 150; and outer peripheral surfaces of the protrusions 250 and inner peripheral surfaces of the through-holes 150 may be welded to couple the fastening bracket 200 and the motor housing 100.

The plurality of through-holes 150 are disposed at regular intervals on the outer peripheral surface of the motor compartment 131, and the through-holes 150 are designed to correspond to the protrusions 250 of the fastening bracket 200, respectively, thereby achieving precise interference coupling. The protrusions 250 are formed to protrude from an inner side of the fastening bracket 200 toward an outer peripheral surface of the fastening bracket 200, and are inserted into the through-holes 150 to serve to secure the motor housing 100 and the fastening bracket 200 in a correct position. The protrusions 250 are inserted into the through-holes 150, and then outer peripheral surfaces of the protrusions 250 and inner peripheral surfaces of the through-holes 150 are welded to provide fixed coupling.

The protrusions 250 may be a component formed during the manufacturing process of the fastening bracket 200; and after the fastening bracket 200 is inserted into the motor housing 100, the protrusions 250 may be formed by burring or embossing in a direction of the through-holes 150 of the motor housing 100.

The coupling of the through-holes 150 and the protrusions 250 ensures accurate alignment of the motor housing 100 and the fastening bracket 200, and enables positioning without error for coupling. As a result, the assembly process becomes easier, and the stability of the coupling portions after assembly is enhanced.

In addition, a plurality of welds are formed at points where the through-holes 150 and the protrusions 250 come into contact with each other, thereby significantly increasing coupling strength between the motor housing 100 and the fastening bracket 200. FIG. 5 is a cross-sectional view taken along line C-C in FIG. 4. Referring to FIG. 5, inner peripheral surfaces of the through-holes 150 and outer peripheral surfaces of the protrusions 250 are welded (see line B), thereby enabling coupling with high durability and resistance to vibration and impact.

The coupling method using the plurality of protrusions 250 and the plurality of through-holes 150 distributes the load applied to the coupling portions across multiple coupling portions, thereby preventing stress concentration at a single coupling portion. This may significantly enhance the durability of the coupling portions during long-term use. In particular, the plurality of protrusions 250 and the through-holes 150 that are disposed at equal angular intervals facilitate positional alignment during assembly, and the strength and stability of the coupling portions may be uniformly maintained after assembly. As a result, long-term durability of the vehicle steering motor assembly is ensured.

In addition, the vehicle steering motor assembly according to the present disclosure may form a fastening guide structure in the motor housing 100 and the fastening bracket 200 for accurate fastening of the motor housing 100 and the fastening bracket 200. In an embodiment, a guide protrusion 140 that partially protrudes in a circumferential direction may be formed on the second coupling portion 1312 of the motor compartment 131, and the hollow 205 of the fastening bracket 200 may be formed with a guide groove 240 that is recessed inward to correspond to the guide protrusion 140. That is, the raised guide protrusion 140 may be formed on the motor housing 100, and the recessed guide groove 240 may be formed in the fastening bracket 200, such that the fastening bracket 200 may be fastened to the motor housing 100 in a predetermined direction.

The guide protrusion 140 is formed on the outer peripheral surface of the second coupling portion 1312 of the motor compartment 131, and has a protrusion shape that protrudes in the circumferential direction. This ensures accurate positional alignment when the motor housing 100 and the fastening bracket 200 are coupled. The guide groove 240 is formed on an inner side of the hollow 205 of the fastening bracket 200, and is designed to accurately correspond to the guide protrusion 140. The guide groove 240 provides a recessed space into which the guide protrusion 140 may be inserted, thereby enabling accurate control of a fastening direction.

The guide protrusion 140 and the guide groove 240 are designed as a unidirectional coupling structure, such that the fastening bracket 200 may be inserted into the motor housing 100 only in a correct direction. This prevents misassembly of components and ensures precise fastening. The mechanical performance of the vehicle steering motor assembly is reliably maintained.

Although certain embodiments of the present disclosure have been illustrated and described, it will be apparent to those skilled in the art to which the present disclosure pertains that various modifications and changes to the present disclosure may be made without departing from the technical spirit of the present disclosure provided in the following claims.

What is claimed is:

1. A vehicle steering motor assembly comprising:
a motor housing in which a motor is accommodated;
a gearbox accommodating a plurality of gears rotatably connected to a motor shaft; and
a fastening bracket disposed between the motor housing and the gearbox, wherein an end of the fastening bracket in contact with the motor housing is welded and coupled to the motor housing, and the fastening bracket connects the motor housing and the gearbox.

2. The vehicle steering motor assembly of claim 1, wherein the motor housing comprises:
a motor compartment covering the motor; and
a controller compartment, in which a controller configured to control the motor is disposed.

3. The vehicle steering motor assembly of claim 2, wherein the motor compartment includes:
a first coupling portion formed at a lower end of the motor compartment for coupling with the controller compartment.

4. The vehicle steering motor assembly of claim 2, wherein the motor compartment includes:
a second coupling portion formed at an upper end of the motor compartment; and
wherein the fastening bracket is coupled to the second coupling portion having an outer diameter smaller than an adjacent portion of the motor compartment.

5. The vehicle steering motor assembly of claim 4,
wherein the motor compartment has a cylindrical shape.

6. The vehicle steering motor assembly of claim 4,
wherein a hollow is formed in a central portion of the fastening bracket, and
wherein the fastening bracket is coupled to the second coupling portion of the motor compartment through the hollow.

7. The vehicle steering motor assembly of claim 6, wherein a third coupling portion coupled to the gearbox is formed at an edge of the fastening bracket.

8. The vehicle steering motor assembly of claim 6,
wherein an inner peripheral surface of the hollow of the fastening bracket and an outer peripheral surface of the second coupling portion are welded to couple the fastening bracket and the motor compartment.

9. The vehicle steering motor assembly of claim 2,
wherein a plurality of through-holes are formed on an outer peripheral surface of the motor compartment, and
wherein a plurality of protrusions protruding toward an outer peripheral surface of the motor housing are formed on the fastening bracket and inserted into the through-holes.

10. The vehicle steering motor assembly of claim 9,
wherein outer peripheral surfaces of the protrusions and inner peripheral surfaces of the through-holes are welded to couple the fastening bracket and the motor housing.

11. The vehicle steering motor assembly of claim 9,
wherein the plurality of through-holes are disposed at equal angular intervals around the center of the motor compartment, and the plurality of protrusions are disposed at equal angular intervals around the center of the fastening bracket.

12. The vehicle steering motor assembly of claim 4,
wherein a guide protrusion configured to partially protrude in a circumferential direction is formed on the second coupling portion of the motor compartment, and
wherein a hollow of the fastening bracket is formed with a guide groove recessed inward to correspond to the guide protrusion.

13. The vehicle steering motor assembly of claim 9,
wherein the motor compartment has a cylindrical shape;
wherein a first coupling portion is formed at a lower end of the motor compartment for coupling with the controller compartment;
wherein a second coupling portion is formed at an upper end of the motor compartment; and
wherein the fastening bracket is coupled to the second coupling portion having an outer diameter smaller than an adjacent portion of the motor compartment.

14. The vehicle steering motor assembly of claim 13,
wherein a guide protrusion configured to partially protrude in a circumferential direction is formed on the second coupling portion of the motor compartment, and
wherein a hollow of the fastening bracket is formed with a guide groove recessed inward to correspond to the guide protrusion.
